(19) United States
(12) Patent Application Publication
(10) Pub. No.: US 2026/0138330 A1
(43) Pub. Date: May 21, 2026

(54) ADDITIVE-MANUFACTURING MATERIAL DEPOSITION METHOD AND APPARATUS

(71) Applicant: KTIO LLC, Coeur D Alene, ID (US)

(72) Inventor: Kenneth TYLER, Coeur D Alene, ID (US)

(21) Appl. No.: 18/955,654

(22) Filed: Nov. 21, 2024

(51) Int. Cl. B29C 64/245; B29C 64/147; B29K 105/12; B29K 507/04; B33Y 10/00; B33Y 30/00

(52) U.S. Cl. CPC B29C 64/245; B29C 64/147; B33Y 10/00; B33Y 30/00; B29K 2105/12; B29K 2507/04

(57) ABSTRACT

An additive-manufacturing material is temporarily disposed on a non-planar surface and then subsequently transferred, at least part, from that non-planar surface to an additive-manufacturing object. By one approach, that non-planar surface comprises the exterior surface of a rotatable cylinder. So configured, the aforementioned transference of at least part of the additive-manufacturing material from the non-planar surface to the additive-manufacturing object occurs while that rotatable cylinder rotates. By one approach, the aforementioned transference from the non-planar surface includes changing a dimension of the non-planar surface. For example, the latter may comprise enlarging the cross-sectional diameter of a cylinder.

### TECHNICAL FIELD

These teachings relate generally to additive manufacturing.

### BACKGROUND

Additive manufacturing, versions of which are sometimes referred to as three-dimensional printing, is a process of creating three-dimensional objects from a digital file by layering materials successively until the entire object is formed. Unlike traditional subtractive manufacturing methods, which involve cutting away material from a solid block to achieve the desired shape, additive manufacturing builds objects by adding material layer by layer, following a pre-set path or design. This method can allow for complex geometries and structures that would be difficult or impossible to achieve with conventional manufacturing techniques, and it can utilize a variety of materials, including plastics, metals, and ceramics.

Carbon fibers have been incorporated into additive manufacturing to enhance the mechanical properties of printed objects. When combined with polymer matrix materials, such as nylon or thermoplastic resins, the resulting composite material can exhibit superior strength, stiffness, and durability compared to its non-reinforced counterparts. In this application setting, carbon fibers can be used in two primary forms: short carbon fiber strands mixed into the filament material, or continuous carbon fiber strands that are, for example, laid down in critical stress areas during the printing process. The integration of carbon fibers can not only reduce the weight of the printed parts but can also significantly increase their structural integrity.

### BRIEF DESCRIPTION OF DRAWINGS

Various needs are at least partially met through provision of the described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a schematic representation as configured in accordance with various embodiments of these teachings;

FIG. 4 comprises a schematic representation as configured in accordance with various embodiments of these teachings;

FIG. 5 comprises a schematic representation as configured in accordance with various embodiments of these teachings;

FIG. 6 comprises a schematic representation as configured in accordance with various embodiments of these teachings;

FIG. 7 comprises a side elevational view as configured in accordance with various embodiments of the invention; and

FIG. 8 comprises a schematic representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments provide for temporarily disposing an additive-manufacturing material on a non-planar surface and subsequently transferring at least part of the additive-manufacturing material from the non-planar surface to an additive-manufacturing object. By one approach, that non-planar surface comprises the exterior surface of a rotatable cylinder. So configured, the aforementioned transference of at least part of the additive-manufacturing material from the non-planar surface to the additive-manufacturing object occurs while that rotatable cylinder rotates. By one approach, the aforementioned transference from the non-planar surface includes changing a dimension of the non-planar surface. For example, the latter may comprise enlarging the cross-sectional diameter of a cylinder.

By one approach, the aforementioned temporary disposition of the additive-manufacturing material on the non-planar surface can take place at a first material extrusion station. Similarly, the aforementioned transference of the additive-manufacturing material from the non-planar surface to the additive-manufacturing object can take place at a first material deposition station.

These teachings are highly flexible in practice and will accommodate various approaches in the foregoing regards. As one example, these teachings will accommodate having a plurality of material extrusion stations and a plurality of material deposition stations. In that case, additive-manufacturing material may be transferred sequentially from a corresponding plurality of non-planar surfaces to the additive-manufacturing object. In such a case, succeeding material deposition stations can be vertically displaced from one another to accommodate a corresponding thickness of the additive-manufacturing material on the additive-manufacturing object at any given one of the material deposition stations.

As another example, these teachings will accommodate pre-loading a plurality of non-planar surfaces at a single one of the material extrusion stations and then using all of those pre-loaded non-planar surfaces at a single material deposition station to cumulatively place additive-manufacturing material on the additive-manufacturing object.

And as yet another example, these teachings will accommodate pre-loading a plurality of non-planar surfaces at each of a plurality of material extrusion stations and then using some or all of those pre-loaded non-planar surfaces at a single material deposition station to again cumulatively place additive-manufacturing material on the additive-manufacturing object.

When employing a plurality of material deposition stations, these teachings will accommodate placing curing activators at locations between those stations. So configured, material disposed on the additive-manufacturing object can be activated before further material is deposited thereon at a next sequentially located material deposition station.

These teachings may be particularly beneficial when the additive-manufacturing material includes carbon fibers (such as a composite carbon fiber material). In particular, these teachings can provide considerable opportunities to reduce the amount of time it takes to apply the various layers of such material to form a desired end shape. As one example in these regards, at least when the non-planar surface is enabled using a cylinder/drum, the print cylinders/drums will allow for highly consistent layer height and compaction, which in turn can allow for an optimal fiber to resin ratio (within, for example, a range from 60:40 to 70:30 by weight).

As another available advantage, the dispersal of the cylinders/drums can also allow for rapid and precise interlaminar material changes. By one approach, for example, the print deposition surface may be heated and/or illuminated along with the print cylinders/drums to enhance interlaminar strength and to initiate or enhance the curing of the liquid matrix material (such as, for example, a thermoplastic thermoset or other binding structure).

And as yet another example, these teachings will accommodate depositing a material comprising fiber in any manner of desired orientation. This capability can therefore support depositing composites having fibers that are oriented in different directions (such as, for example, a perpendicular quasi-axial segment). As one example in these regards, a single extrusion comprising a tow of fibers can be extruded straight up off the non-planar surface during a first phase and then rotated into a desired position. (A tow of fibers will be understood to refer to a bundle or collection of continuous fibers that can serve, for example, to reinforce the material being printed. These fibers can be made of various materials such as carbon, glass, or aramid, and, if desired, can be impregnated with a thermoplastic or thermoset polymer matrix to form a composite material.)

These teachings will also permit layering many different materials (including, if desired, radically different materials). Such material may be layered together, discreetly and precisely, within a same layer, or from layer to layer as desired. As a simple illustrative example in these regards, consider a wristband that can be comprised of meta materials through precise control of the layer heights and the ability to modify layers in situ. Such a wristband can be printed having outer polymer layers for comfort and waterproofing followed by layers of one or more other materials to apply some stiffness as well as meta components to create radio frequency identification and or near-field communication components, batteries, one or more lights (or even a display), and so forth. These teachings will accommodate the production of hundreds of such items on a single build plate.

These teachings will also permit the printing of very thin and lightweight objects, including, for example, a thin, flexible display. These teachings can further allow for the printing of compact and diverse airframes of various sizes and with many layers of materials (including layers of predominantly reinforced fibers). The present ability to integrate meta materials within the printed structure would also allow for the development of new types of airframe structures having, for example, embedded batteries, motors, rotors, lights, antennae, and other functional components to thereby yield, for example, a drone frame featuring an inside out electrical motor and rotors for a ducted propeller design that utilizes minimal components.

As yet another example, these teachings will accommodate printing a flexible circuit on a very thin membrane material that may be used, for example, in clothing. The circuit paths in this flexible circuit may be a solid copper or a liquid metal suspended in a flux that is activated with heat or even a liquid material that is encased by polymer when applied via a cylinder/drum per these teachings.

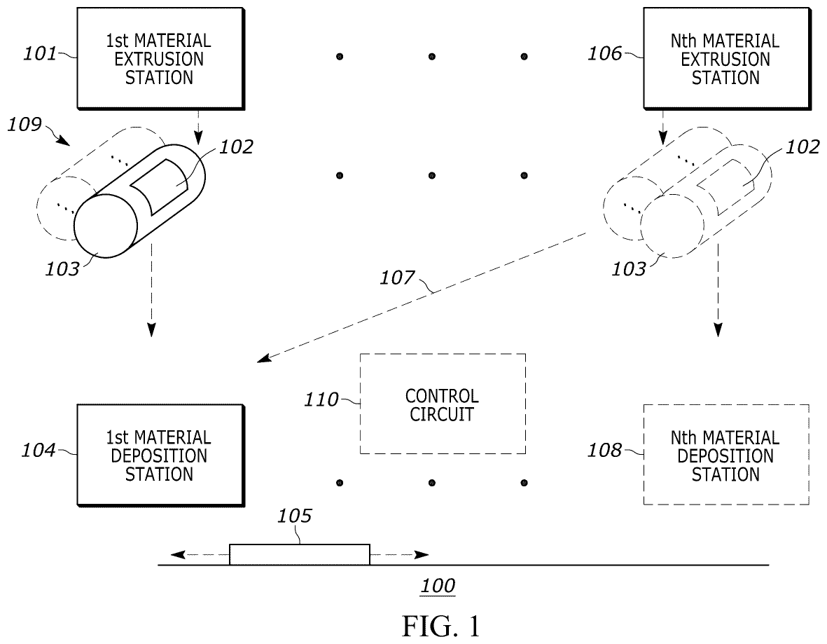

These and other benefits may become clearer upon making a thorough review and study of the following detailed description. Referring now to the drawings, and in particular to FIG. 1, an illustrative apparatus 100 that is compatible with many of these teachings will first be presented.

In this particular example, the apparatus 100 includes a first material extrusion station 101. This first material extrusion station 101 includes an additive-manufacturing material extrusion system to extrude and dispose additive-manufacturing material 102 of choice (including, for example, additive-manufacturing material that includes carbon fibers) onto a surface. As will be described in more detail below, the latter surface may comprise a non-planar surface such as a rotatable cylinder 103 (sometimes also referred to herein as a print drum).

In this example, the apparatus 100 also includes a first material deposition station 104. At the first material deposition station 104, the additive-manufacturing material 100 is transferred from the aforementioned non-planar surface onto an additive-manufacturing object 105. Generally speaking, the foregoing process can be repeated to build up the desired additive-manufacturing object, layer by layer.

These teachings are highly flexible in practice and will accommodate various alterations and/or additional features. As one example, the first material extrusion station 101 can serve to place additive manufacturing material on each of a plurality of discrete non-planar surfaces. Those non-planar surfaces can then be utilized, one by one, at the first material deposition station 104 to print the additive manufacturing material 102 on to the additive-manufacturing object 105.

As another example, these teachings will accommodate having a plurality of material extrusion stations (represented in FIG. 1 by an Nth material-extrusion station 106, where N represents any integer greater than 1). By one approach, some or all of the aforementioned rotatable cylinders 103 bearing additive-manufacturing material 102 as produced by these additional material extrusion stations can be transferred to (as represented by the dashed line 107) and utilized at the first material deposition station 104 to transfer and print additive manufacturing material 102 onto the additive-manufacturing object 105.

By yet another approach, these teachings will accommodate having a plurality of material deposition stations (represented in FIG. 1 by an Nth material-deposition station 108, where N represents any integer greater than 1). The resultant plurality of material-deposition stations can be sequentially arranged to deposit/print their respective additive-manufacturing material offerings on to the additive-manufacturing object 105 as the latter passes by each material deposition station.

By one approach, the apparatus 100 may include a control circuit 110 that is configured to carry out one or more of the steps described herein. For example, this control circuit 110 can be configured to cause additive-manufacturing material that is temporarily disposed on the non-planar surfaces described herein to be transferred to an additive-manufacturing object. Being a “circuit,” the control circuit 110 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 110 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 110 is configured (for example, by using corresponding programming as will be well understood by those skilled in the art) to carry out one or more of the steps, actions, and/or functions described herein.

By one optional approach the control circuit 110 operably couples to a memory. This memory may be integral to the control circuit 110 or can be physically discrete (in whole or in part) from the control circuit 110 as desired. This memory can also be local with respect to the control circuit 110 (where, for example, both share a common circuit board, chassis, power supply, and/or housing) or can be partially or wholly remote with respect to the control circuit 110 (where, for example, the memory is physically located in another facility, metropolitan area, or even country as compared to the control circuit 110). It will also be understood that this memory may comprise a plurality of physically discrete memories that, in the aggregate, store the pertinent information that corresponds to these teachings.

This memory can serve, for example, to non-transitorily store computer instructions that, when executed by the control circuit 110, cause the control circuit 110 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

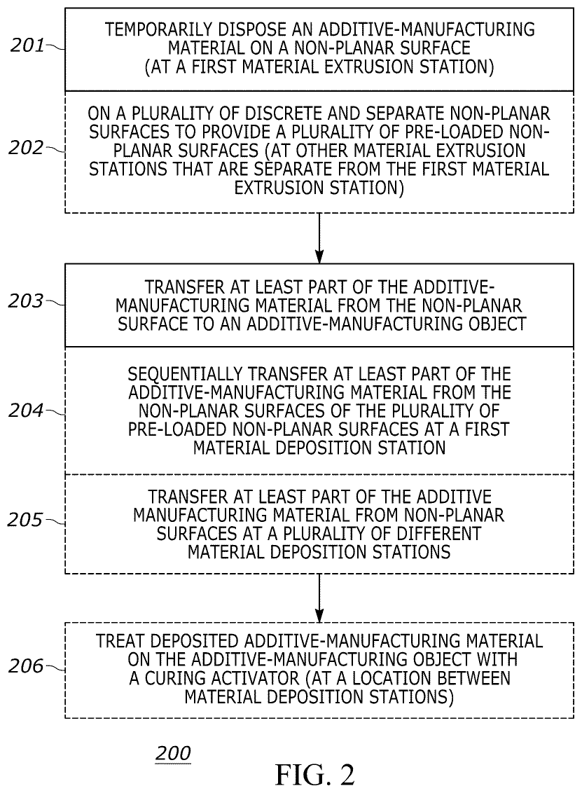

With reference to FIG. 2, a process 200 that can be carried out in conjunction with the above-described apparatus 100 will now be presented. As desired, some or all of the described steps may be carried out in whole or in part under the control of the aforementioned control circuit 110.

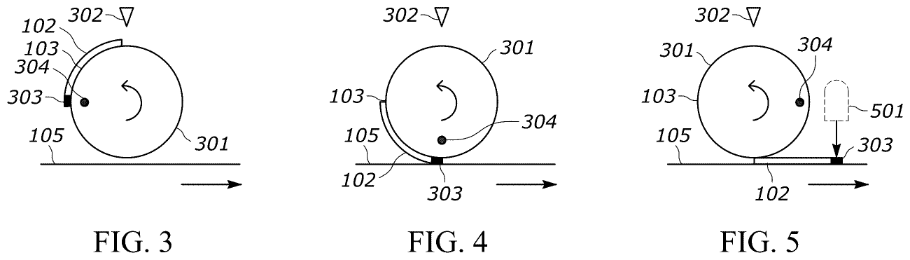

At block 201 (and referring as well to FIG. 3), this process 200 provides for temporarily disposing an additive-manufacturing material 102 on a non-planar surface 301. This activity can occur, for example, at a material extrusion station such as the first material extrusion station 101 described above. The additive-manufacturing material 102 can be so disposed by use of a print head 302 that may be comprised, for example, of a plurality of nozzles. (Print heads comprise a well understood area of practice. As the present teachings are not overly sensitive to any particular selections in these regards, further elaboration regarding print heads is not provided here.) In particular, the additive-manufacturing material 102 can be disposed on the non-planar surface 301 while the rotatable cylinder 103 rotates. For the sake of an illustrative example, it may be presumed here that the additive-manufacturing material 102 comprises a meta-material such as any of hundreds (or even thousands) of so-called continuous materials (such as, but certainly not limited to, carbon fibers) that are disposed within a liquid matrix material.

The reference to being temporarily disposed in this description refers to the physical state of the additive-manufacturing material 102 itself. In particular, at this stage of the process 200, the additive-manufacturing material 102 remains pliable and non-hardened. This reference to being temporarily disposed also refers to this stage of the process 200, where the intent is to only retain the additive-manufacturing material 102 on this non-planar surface 301 as an intermediate step before curing and hardening the additive-manufacturing material 102 on a different surface.

For the sake of illustration, a leading portion of the deposited additive-manufacturing material 102 is blackened and denoted by reference numeral 303. Also for the sake of illustration, a black circle denoted by reference numeral 304 is shown on the rotatable cylinder 103 to illustrate different rotational positions in these figures.

By one optional approach, and as denoted at block 202, these teachings will accommodate temporarily disposing an additive-manufacturing material 102 on each of a plurality of discrete and separate non-planar surfaces 301 to thereby provide a plurality of pre-loaded non-planar surfaces 301. This creation of a plurality of pre-loaded non-planar surfaces 301 can be undertaken at a single material extension station as is represented in FIG. 1 by reference numeral 109. In lieu of the foregoing, or in combination therewith, these pre-loaded non-planar surfaces 301 can be formed at other material extrusion stations that are separate from the first material extrusion station 101. So configured, a stockpile of pre-loaded non-planar surfaces 301 can then be available for sequential use by one or more material deposition stations.

At block 203, this process 200 provides for transferring at least part of the additive-manufacturing material 102 (or, usually more preferably, all of the additive-manufacturing material 102 save perhaps small traces of residual material) from the non-planar surface 301 to an additive-manufacturing object 105.

Referring momentarily to FIG. 4, the rotatable cylinder 103 can rotate in order to bring the additive manufacturing material 102 disposed thereon into contact with the additive-manufacturing object 105. At the same time, the additive manufacturing object 105 can itself be moving orthogonally to the rotatable cylinder 103. These two bodies can continue their respective motion until, as illustrated in FIG. 5, the additive-manufacturing material 102 is fully transferred from the non-planar surface 301 to the additive-manufacturing object 105.

These teachings will accommodate any of a variety of approaches for facilitating the above-described transfer of material. By one approach, for example, the rotatable cylinder 103 may have internal mechanical components that can cause one or more dimensions (such as a cross-sectional diameter) of the non-planar surface 301 to change (for example, by enlarging the diameter of the rotatable cylinder 103).

As another example, the rotatable cylinder 103 can include one or more valves that connect to a pressurized source of gas, which gas, when selectively introduced into the rotatable cylinder 103, causes the rotatable cylinder 103 to slightly expand and disrupt surface tension that may be adhering the additive-manufacturing material 102 to the non-planar surface 301.

As yet another example, thermal properties may be leveraged to facilitate, in whole or in part, removing the material from the non-planar surface 301. Rapid cooling of at least a portion of the non-planar surface 301, by one approach, may serve, at least in part, to cause a deposited material (such as a thermoplastic material) to separate from the non-planar surface 301. Rapid cooling may be facilitated in any of a variety of ways. By one approach, and as one illustrative example in these regards, one or more interior nozzles can be configured to spray a cold substance (such as, but not limited to, liquid nitrogen) on an interior surface of the non-planar surface 301.

And as yet another example, selective sonication or the like can serve to use vibration, in whole or in part, to loosen the material and to allow the aforementioned transfer of material to occur in a controlled manner. By one approach, such vibrations can be caused, at least in part, by selectively energized piezoelectric materials that are attached to the non-planar surface 301

Yet another way to effect such a transfer can employ a combination of heat-based initiation for thermoplastic materials, ultraviolet-based initiation, and dual-component reactive polymer matrix systems that typically employ both a resin and a corresponding hardener (or curing agent). For the sake of a non-limiting example, consider material that is built up upon the cylinder with an ultra violet matrix process and then on top of the final layer a Matrix A is deposited with one set of reactive components (such as, for example, a base resin, monomers, or prepolymers) along with other ingredients like accelerators, fillers, or additives. A Matrix B can contain a complementary set of reactive components (such as, for example, a curing agent, hardener, or another type of resin/monomer) designed to chemically react with Matrix A upon contact. Matrix B can be applied to the top of the last layer deposited on the build plate. When the deposition material with Matrix A rotates around to the deposition location with Matrix B, a contact-based initiation will occur. Instant bonding and hardening are possible. In particular, the contact between the two matrices triggers an exothermic reaction (a reaction that releases heat) or other chemical processes (such as condensation or addition reactions). These processes, in turn, cause the materials to polymerize (such that monomers in both matrices link together to form long-chain polymers) and to cross-Link (such that polymer chains from each matrix chemically bond, forming a three-dimensional network that rapidly solidifies). The foregoing can result in an instantaneous bond at the interface, with the reaction propagating quickly throughout the volume of the bonded area, leading to complete curing and hardening.

With the foregoing in mind, the material(s) that comprises the rotatable cylinder 103 can vary with the potential requirements and/or opportunities that are presented by a given application setting. Some factors that may be taken into account include, but are not limited to, thermal properties (since thermoplastic and thermoset materials typically require heat during processing, the rotatable cylinder material should tolerate that corresponding temperature range in an application setting that employs such materials), mechanical strength (since the rotatable cylinder may need to resist various mechanical stresses from such causes as winding, unwinding, contact with fibers and electronic components, and so forth), and chemical resistance (as the rotatable cylinders may come into contact with specific adhesives, resins, or other materials and chemicals during the processes that typify the application setting.

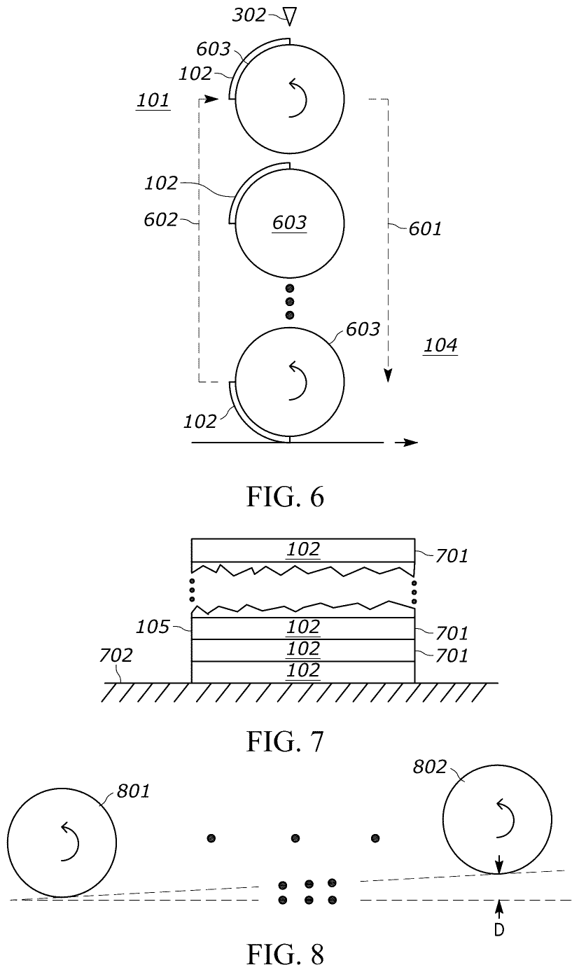

By one approach, the rotatable cylinder 103 remains in a single location during all of the above-described steps. These teachings are flexible enough to accommodate other approaches, however. For example, and referring momentarily to FIG. 6, The first material extrusion station 101 may be located physically distant from the location of the first material deposition station 104. That distance may be relatively short, such as a few centimeters, or may be relatively long and involve, for example, moving the rotatable cylinder 103 from one building to another. FIG. 6 presents a loaded rotatable cylinder 603 as it moves from the first material extrusion station 101 to the first material deposition station 104 as denoted by the phantom arrow line bearing reference numeral 601. Once the additive-manufacturing material 102 has been disposed at the first material deposition station 104, that rotatable cylinder 603 can then be moved again (as denoted by reference numeral 602) to the first material extrusion station 101 (or any other material extrusion station of choice) to repeat the process. If desired, a treatment of choice may be applied to the exterior of the rotatable cylinder 603 to help prevent the additive-manufacturing material 102 from adhering too firmly to the rotatable cylinder 603.

As described above, these teachings will accommodate temporarily disposing the additive-manufacturing material 102 on each of a plurality of discrete and separate non-planar surfaces to provide a plurality of pre-loaded non-planar surfaces (illustrated in FIG. 1 by the plurality of rotatable cylinders 103 denoted by reference numeral 109). This plurality of pre-loaded non-planar surfaces may be provided from a single material extrusion station (such as the above-described first material extrusion station 101) and/or may be provided by one or more additional material extrusion stations. In such a case, and referring again to FIG. 2 at optional block 204, these teachings will accommodate sequentially transferring at least part of the additive-manufacturing material 102 from each of the non-planar surfaces 301 of that plurality of pre-loaded non-planar surfaces at a first material deposition station 104.

Also as described above, these teachings will accommodate employing a plurality of material deposition stations. In such a case, and as illustrated at optional block 205, this process 200 will accommodate transferring at least part of the additive-manufacturing material 102 from non-planar surfaces 301 at each of a plurality of different material deposition stations. As one simple example in these regards, additive-manufacturing material 102 may be transferred from a first non-planar surface to the additive-manufacturing object 105 at a first material deposition station 104 followed by then transferring at least part of the additive manufacturing material 102 that is disposed on a second non-planar surface to the additive-manufacturing object at a second material deposition station that is separate from the first material deposition station. There is no particular limit to the number of material deposition stations that may be sequentially ordered in this manner.

In many application settings, subsequent material deposition stations will be disposing additive-manufacturing material onto previously disposed additive-manufacturing materials to thereby build up the additive manufacturing object 105. FIG. 7 presents a simple illustrative example in these regards, where the additive manufacturing object 105 is seen to be comprised of a plurality of layers 701 of additive-manufacturing material 102 that are disposed atop a supporting platform 702 that is configured to receive the additive-manufacturing object 105 during the aforementioned deposition process. (It will be understood that the additive-manufacturing object 105 may also include temporary scaffolding that is also comprised of additive-manufacturing material 100.)

Accordingly, as the additive manufacturing object 105 is successively processed by each material deposition station, the height of the additive-manufacturing object 105 will increase with each deposited layer. With that in mind, these teachings will accommodate having subsequent non-planar surfaces at their respective material deposition station be vertically displaced from one another. In particular, that relative height can increase by a distance corresponding to the thickness of the additive-manufacturing material 102 that was transferred to the additive-manufacturing object 105 by the previous material deposition station(s). FIG. 8 presents an illustrative example in these regards, where the relative height of a final non-planar surface 802 in a series of non-planar surfaces is shown to be a positive value D as compared to the first non-planar surface 801 in that series.

Many additive manufacturing materials require, or at least benefit from, additional processing in order to harden the material following its deposition. Referring to FIGS. 2 and 5, these teachings will therefore accommodate treating deposited additive-manufacturing material 102 on the additive-manufacturing object 105 with a curing activator 501. Ultraviolet light, for example, can be applied in these regards with some additive-manufacturing materials 102. As noted above, these teachings will accommodate having a series of material deposition stations. In such an application setting, these teachings will accommodate having a curing activator 501 at each location between such material deposition stations. So configured, deposited additive-manufacturing material 102 can be cured (or curing can at least be initiated) prior to a next application of such material.

The applicant has determined that the aforementioned print drum may take many different forms depending on the intended application setting. By one approach, the print drum may be a hollow cylinder comprised of a polymer of a polycarbonate, polyether ether ketone (PEEK), nylon, polytetrafluoroethylene (PTFE), and/or various metals such as aluminum, stainless steel, or titanium as well as any of a variety of composite materials such as carbon fiber reinforced polymers (CFRP), glass fiber reinforced polymers (GFRP), and so forth. Different print drums may be individually better suited for different corresponding material applications and layers.

Print drums, including print drums that differ from one another in any of a variety of ways, may be interspersed amongst one another in a given manufacturing setting as desired. In some cases these print drums may not be hollow but may be comprised of a metal that can expand and contract due to heat or electric current, such as shape memory alloys (SMA) such as Nitinol which can return to a predetermined shape when sufficiently heated.

In some cases the print drums may be configured so that the print drum may compress in one or more dimensions for shipping purposes and/or for storage and then be uncompressed at a time of need.

By one approach, print drums may be attached and un-attached from nested locations within a print assembly configured to deposit the print material to a linear actuated print bed. These teachings will accommodate employing an array of print drums in a queue that allows the linear print bed to move continuously, or nearly continuously, while drums that have deposited their print segment are sequentially replaced with subsequent drums containing material for subsequent depositions. Moving print drums in and out of the deposition process can be an ever-present aspect of the process, with one layer and/or layer segment being deposited and the corresponding now-empty print drums being transferred out of the print bed area and to a reloading station.

The size of the print drum may vary depending on the application setting, machine size, or other relevant factors. By one approach, the print drum may require a significant tangential sweep to allow a smooth transfer of print material from the print drum to a build plate. By one approach, a print drum having a 6 to 12 inch diameter and being 12 to 48 inches in length may be of suitable size for smaller to average size manufactured parts, though it should be understood that there are not any particular limits regarding the size and/or scope of the print drum and/or layer heights.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

As but one example in these regards, the apparatus may only contain necessary mechanical components for the deposition from print cylinders. For example, the print cylinder might comprise a tightly rolled flexible paper or thin plastic sheet that has different printed layers or images of corresponding layers. In such a case, the print cylinder may be created by another apparatus and one such cylinder may have multiple corresponding layers rolled together that are ready for sequential deposition. The latter might comprise a core cylinder of minimum circumference with a plurality of print layers rolled up thereon and available to be applied to a flat thin sheet material intermediary surface. Such print layers could then be subsequently removed from the flat sheet intermediary surface (the latter then being reused or discarded as desired). Such an approach would be helpful in an application setting that is specific to producing one product or in a remote setting where a simple apparatus is desired to make only certain desired products, and where the precursor assembly components arrive at the arrival dock as boxes or pallets of pre-loaded cylinders.

As another example in these regards, these teachings can be carried out in combination with pyrolization techniques. So configured, and as an example, a deposited carbon matrix composite can be converted to a carbon-carbon composite material (to thereby yield, for example, a result object that will retain its shape and functionality at high operating temperatures).

And as yet another example in these regards, these teachings can be carried out in combination with other approaches to also deposit additive materials to an object being printed using the above-described teachings. By one approach, for example, microjetting techniques can be used to deposit high resolution layers upon layers that were previously printed via the aforementioned print cylinders/drums. Such an approach could serve, for example, to print electrically-conductive traces on one or more layers of material that were previously printed using the print cylinders/drums.

1. A method comprising:
temporarily disposing an additive-manufacturing material on a non-planar surface;
transferring at least part of the additive-manufacturing material from the non-planar surface to an additive-manufacturing object.

2. The method of claim 1 wherein the additive-manufacturing material includes carbon fibers.

3. The method of claim 1 wherein the non-planar surface comprises an exterior surface of a rotatable cylinder.

4. The method of claim 3 wherein transferring at least part of the additive-manufacturing material from the non-planar surface to an additive-manufacturing object comprises transferring at least part of the additive-manufacturing material from the non-planar surface to an additive-manufacturing object while the rotatable cylinder rotates.

5. The method of claim 4 wherein transferring at least part of the additive-manufacturing material from the non-planar surface to the additive-manufacturing object includes at least one of:
changing a dimension of the non-planar surface;
a contact-based initiation;
ultraviolet-based initiation; and
heat-based initiation.

6. The method of claim 5 wherein changing the dimension of the non-planar surface comprises enlarging a diameter of a cylinder.

7. The method of claim 1 wherein transferring at least part of the additive-manufacturing material from the non-planar surface to an additive-manufacturing object comprises transferring at least part of the additive-manufacturing material from the non-planar surface to the additive-manufacturing object at a first material deposition station.

8. The method of claim 7 wherein temporarily disposing an additive-manufacturing material on a non-planar surface comprises temporarily disposing additive-manufacturing material on a plurality of discrete and separate non-planar surfaces to provide a plurality of pre-loaded non-planar surfaces.

9. The method of claim 8 wherein transferring at least part of the additive-manufacturing material from the non-planar surface to the additive-manufacturing object comprises sequentially transferring at least part of the additive-manufacturing material from the non-planar surfaces of the plurality of pre-loaded non-planar surfaces to the additive-manufacturing object at the first material deposition station.

10. The method of claim 7 wherein temporarily disposing an additive-manufacturing material on a non-planar surface comprises:
temporarily disposing an additive-manufacturing material on a first non-planar surface at a first material extrusion station;
temporarily disposing an additive-manufacturing material on a second non-planar surface at a second material extrusion station that is separate from the first material extrusion station.

11. The method of claim 10 wherein transferring at least part of the additive-manufacturing material from the non-planar surface to the additive-manufacturing object comprises:
transferring at least part of the additive-manufacturing material from the first non-planar surface to the additive-manufacturing object at the first material deposition station;
transferring at least part of the additive-manufacturing material from the second non-planar surface to the additive-manufacturing object at a second material deposition station that is separate from the first material deposition station.

12. The method of claim 11 wherein the second non-planar surface is vertically displaced with respect to the first non-planar surface.

13. The method of claim 12 wherein the vertical displacement has a distance that corresponds to a thickness of the additive-manufacturing material on the additive-manufacturing object.

14. The method of claim 11 further comprising:
treating deposited additive-manufacturing material on the additive-manufacturing object with a curing activator at a location between the first and second material deposition stations.

15. The method of claim 1 wherein the additive-manufacturing object comprises, in part, temporary scaffolding.

16. An apparatus comprising:
a non-planar surface;
a platform configured to receive an additive-manufacturing object;
a control circuit configured to cause additive-manufacturing material that is temporarily disposed on the non-planar surface to be transferred to the additive-manufacturing object.

17. The apparatus of claim 16 wherein the additive-manufacturing material includes carbon fibers.

18. The apparatus of claim 16 wherein the non-planar surface comprises an exterior surface of a selectively rotatable cylinder and wherein the control circuit is configured to cause the additive-manufacturing material that is temporarily disposed on the non-planar surface to be transferred to the additive-manufacturing object by, at least in part, selective rotation of the selectively rotatable cylinder.

19. The apparatus of claim 18 wherein the control circuit is further configured to transfer the additive-manufacturing material from the non-planar surface to the additive-manufacturing object by, at least in part, at least one of:
changing a dimension of the non-planar surface;
a contact-based initiation;
ultraviolet-based initiation; and
heat-based initiation.

20. The apparatus of claim 19 wherein the non-planar surface comprises a selectively rotatable cylinder and wherein the control circuit is configured to change the dimension of the non-planar surface, at least in part, by changing a cross-sectional diameter of the rotatable cylinder.
